(19) United States
(12) Patent Application Publication
(10) Pub. No.: US 2009/0106127 A1
(43) Pub. Date: Apr. 23, 2009

(54) SYSTEM AND METHOD FOR AUTOMATED ENTRY INTO ON-LINE AUCTION OR SALE SERVICES EMPLOYING A WIRELESS DEVICE

(75) Inventors: Travis Purdy, Santa Barbara, CA (US); Tyler Gildred, Shell Beach, CA (US)

Correspondence Address: FELIX L. FISCHER, ATTORNEY AT LAW, 1607 MISSION DRIVE, SUITE 204, SOLVANG, CA, 93463, US

(73) Assignee: ZUUJIT, LLC, Santa Barbara, CA (US)

(21) Appl. No.: 12/253,503

(22) Filed: Oct. 17, 2008

Related U.S. Application Data
(60) Provisional application No. 60/981,416, filed on Oct. 19, 2007.

(51) Int. Cl. G06Q 30/00; H04N 5/225

(52) U.S. Cl. 705/27; 348/207.99

(57) ABSTRACT

A system for prompting data input by a user on a wireless device to prepare a listing for an item to be sold on a sales service provider site utilizing an integrated camera on the wireless device to obtain images of the item which are integrated into the listing. Upon completion of the listing, a sales service provider is contacted wirelessly by the device and the listing is transferred to the provider. Upon completion of a transaction by the provider, the wireless device receives transaction data for completion of the sale by the user. Prompts are provided on the display using screens with touchpad capability for data entry. Still and video images are prompted by the system and integrated camera capability in the wireless device is used to obtain the images.

### REFERENCE TO RELATED APPLICATIONS

This application claims priority of U.S. Provisional Application Ser. No. 60/681,416 filed on Oct. 19, 2007, by Travis Purdy and Tyler Gildred entitled SYSTEM AND METHOD FOR AUTOMATED ENTRY INTO ON-LINE AUCTION OR SALE SERVICES EMPLOYING A WIRELESS DEVICE which is incorporated herein by reference.

### FIELD OF THE APPLICATION

The present application relates to on-line auction services accessed by public users and more particularly to a system and method for data development and entry in the auction system using a wireless device such as a personal digital assistant or smart cellular phone with integrated imaging input.

### BACKGROUND

Hundreds of thousands and eventually millions of users will regularly employ on-line auction services for the sale of personal goods. Present systems such as eBay®, a service of eBay, Inc., Amazon or Craigslist use an on-line interface accessible to users over the internet to enter data associated with a proposed sale item and to upload various data. To accomplish these tasks the user must have access to a personal computer with an internet connection and have previously created all uploadable data such as photographs or other information. While the entry operations and registration services are relatively automated for most current online services, data entry and system operations are still quite tedious and time consuming.

Certain systems have been developed to allow limited data entry and participation in online auction systems using a remote wireless hand-held device. For example U.S. patent application Ser. No. 09/788,417 to Teveler et al. entitled “Electronic Contract Broker and Contract Market Maker Infrastructure” filed Feb. 21, 2001 and U.S. patent application Ser. No. 10/404,410 to Lammle et al. entitled “Automated Auction Sales Management Tool” filed Apr. 1, 2003 disclose detailed systems and processes for creation of internet auction bids and bidding system interactions which significantly improve the ability of a user to remotely enter data and participate in the auction process. However, data development and entry still require a detailed and time consuming process.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one aspect of the present application, a system having a camera equipped wireless device such as a cellular phone or personal digital assistant (PDA) for receiving data input by a user to record an image and prepare a listing for an item to be sold is presented. A PDA, described by this application, is an exemplary device. As such, devices working with this system include a cell phone, lap top computer, IPTV remote control, web tablet, pocket PC, and mobile IP devices, etc. An integrated camera in the wireless device is employed to obtain images of the item which are integrated into the listing. Upon completion of the listing, a sales service provider is contacted wirelessly by the device and the listing is transferred to the provider. Upon completion of a transaction by the provider, the wireless device receives transaction data for completion of the sale by the user.

In accordance with another embodiment of the present application, a method for using an advanced wireless PDA or smart cellular phone is presented. The method includes prompting for data entry on a display having touchpad capability. In addition, still and video images are prompted by the method having an integrated camera capability in the PDA or phone to obtain the images.

In accordance with yet another aspect of the present application, a method for listing an item for sale using a wireless communication device requesting entry of image data and initiating an integrated camera mode in the device to create an image of an item is presented. The image taken by the user is displayed and the user determines if the image is acceptable and, if affirmative, saves the image. If the determination is not affirmative the device reverts to the camera mode. Upon saving the image, descriptive data for the item is requested and received. The descriptive data and image data are then stored on the device as a listing. The listing is submitted wirelessly through the device to a sales service provider host.

In accordance with another aspect of the present application, the method of requesting and receiving descriptive data for the item is accomplished by requesting an image description, entering a description of the image on the keypad, requesting an item name on a display of a wireless device, accepting entry of the name using a keypad on the device, requesting a listing title, accepting entry of the listing title on the keypad, requesting identifying data for the item, and accepting entry of the indentifying data on the keypad.

In accordance with another aspect of the present application, a wireless device is presented which includes a camera, at least one processor, a graphical user interface (GUI), and a memory operatively coupled to the processor. The memory stores program instructions that when executed by the processor cause the processor to receive an image from the camera associated with an item. The program instructions further cause the processor to display the image on the GUI with the image capable of being accepted through the GUI. Descriptive data for the image associated with the item is requested and received by the processor when the image has been accepted through the GUI and the descriptive data and image are stored in the memory as a listing. The program instructions then cause the processor to transmit the listing wirelessly to a host server.

In yet another aspect of the present application, a computer program product is presented for a user computer system including a processor, a display, a user input device, and a camera for listing an item on a host server. The computer program product included in a computer-readable memory as modules of code. A first module of code directs the processor to install components on the system. A second module of code directs the processor to receive an image from the camera and descriptive data associated with the item for generating the listing and transmit and verify the listing to the host server. A third module of code directs the processor to notify the user of the listing.

In accordance with another aspect of the present application, a system for listing an item on an online auction or sale service is presented. The system includes a network and a wireless communication device for transmitting a listing to the online auction or sale service through the network. The wireless communication device obtains image data of the item from a camera coupled to the wireless communication device, displays the image to a user of the wireless communication device, and if accepted by the user, request and receives descriptive data for the item to generate the listing. In addition, the system includes a provider host for receiving the listing through the network and hosting the online auction or sale service. The provider host receives registration information from the wireless communication device, verifies the information, and if verified, displays the listing on the online auction or sale service provided by the provider host.

In accordance with another aspect of the present application, a server coupled to a network for hosting an online auction or sale service is presented. The server includes at least one processor and memory operatively coupled to the processor, the memory storing program instructions that when executed by the processor, causes the processor to perform a plurality of processes. The program instructions, when executed, cause the processor to receive registration information from at least one wireless communication device through the network and verify the registration information from the at least one wireless communication device. If valid registration information is received, the program instructions, when executed, cause the processor to accept listing information from the at least one wireless communication device, wherein the listing information contains image data and descriptive data of an item to place on the online auction or sale service hosted by the server, the image data taken from a camera coupled to the at least one wireless communication device.

### BRIEF DESCRIPTION OF THE DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1A is a block diagram showing an exemplary architecture depicting elements contained within an illustrative remote wireless device in accordance with one aspect of the present application;

FIG. 1B is a block diagram showing an exemplary architecture for interaction between the remote wireless device, the service system and the sales listing system in accordance with one aspect of the invention;

FIG. 2A is a block diagram depicting an illustrative registration process in accordance with one aspect of the present application;

FIG. 2B is a block diagram depicting an illustrative account creation and selection process in accordance with one aspect of the present application;

FIG. 3A is a block diagram depicting an illustrative listing process in accordance with one aspect of a first embodiment of the present application;

FIG. 3B is a block diagram depicting an illustrative service system server companion processes for listing items in accordance with one aspect of a first embodiment of the present application;

FIGS. 3C, 3D and 3E are block diagrams depicting an illustrative listing process in accordance with a second embodiment of the present application with interactive service system server companion processes;

FIG. 4 is a block diagram illustrating an exemplary post sale process in accordance with one aspect of the present application;

FIGS. 5A through 5I are exemplary implementations of the illustrative system on a PDA or cell phone for the listing process including data entry and imaging in accordance with one aspect of the present application;

FIGS. 6A through 6C are exemplary implementations of the illustrative system on a PDA or cell phone for account maintenance and review in accordance with one aspect of the present application; and

FIGS. 7A and 7B are exemplary implementations of the illustrative system of the PDA or cell phone for post sale shipment and other general functions in accordance with one aspect of the present application.

### DETAILED DESCRIPTION

The detailed description set forth below in connection with the appended drawings is intended as a description of presently-preferred embodiments of the application and is not intended to represent the only forms in which the present application may be constructed and/or utilized. The description sets forth the functions and the sequence of steps for constructing and operating the application in connection with the illustrated embodiments. It is to be understood, however, that the same or equivalent functions and sequences may be accomplished by different embodiments that are also intended to be encompassed within the spirit and scope of this application.

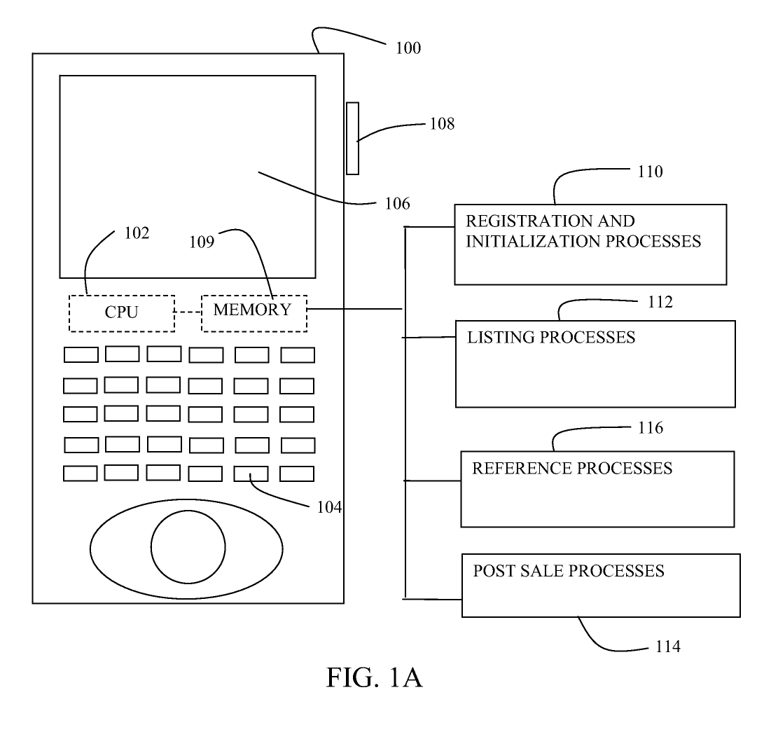

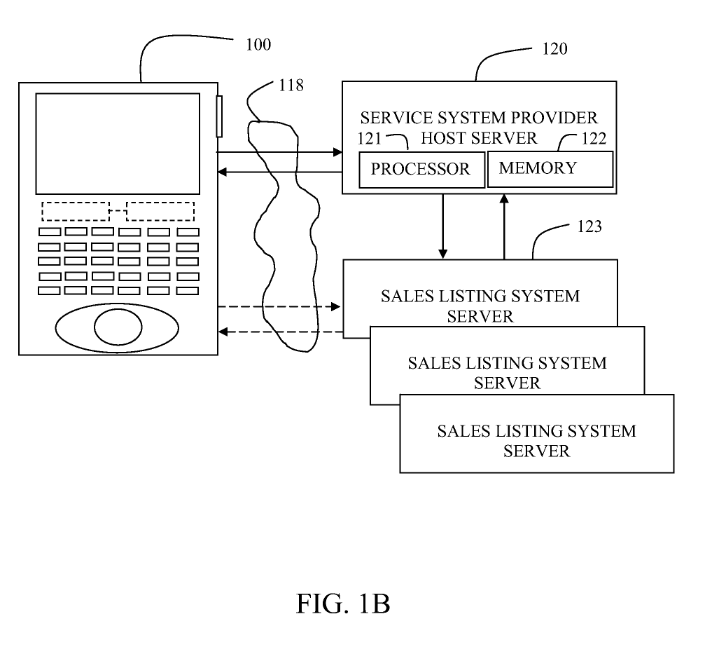

The application incorporates a wireless device as shown in FIG. 1A such as a cellular phone or PDA 100 having an integral central processing unit (CPU) 102, an input keyboard 104, display 106 and an integrated camera 108. An operating memory 109 interacts with the CPU and incorporates multiple processing modules including a Registration and Installation Process 110 for installing components of the system on the PDA 100, a Listing Process 112 for employing the PDA within the installed system and integrated camera for entering the sales details of an item and communication with the selling agency for transmission/verification of the sales details and a Post Sale Process 114 for transaction notification and completion. Embodiments of the application as implemented include additional functions for preference settings and reference processes 116 associated with the PDA operation for listing development and communication with the selling agency.

As shown in FIG. 1B, the PDA communicates over a network 118 with a provider host server 120 for a service system that provides downloads of the various modules to the PDA. The server incorporates processor 121 and a memory 122 or other storage capability. In certain embodiments, the provider host servers interface with servers 123 of a sales listing system for actual communication of listings. In alternative embodiments, the PDA communicates directly with the sales listing system servers for actual listing of the item for sale.

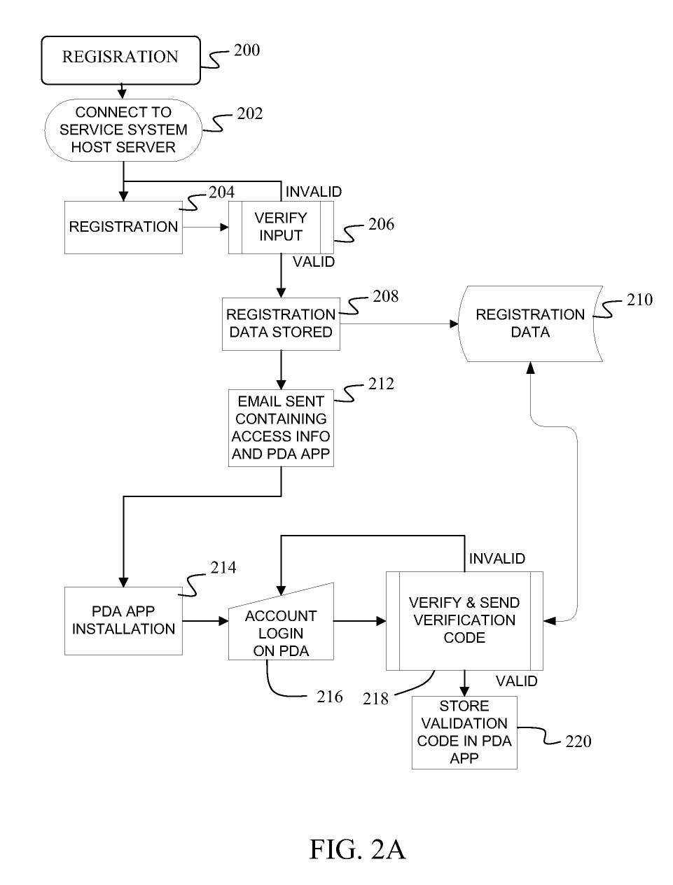

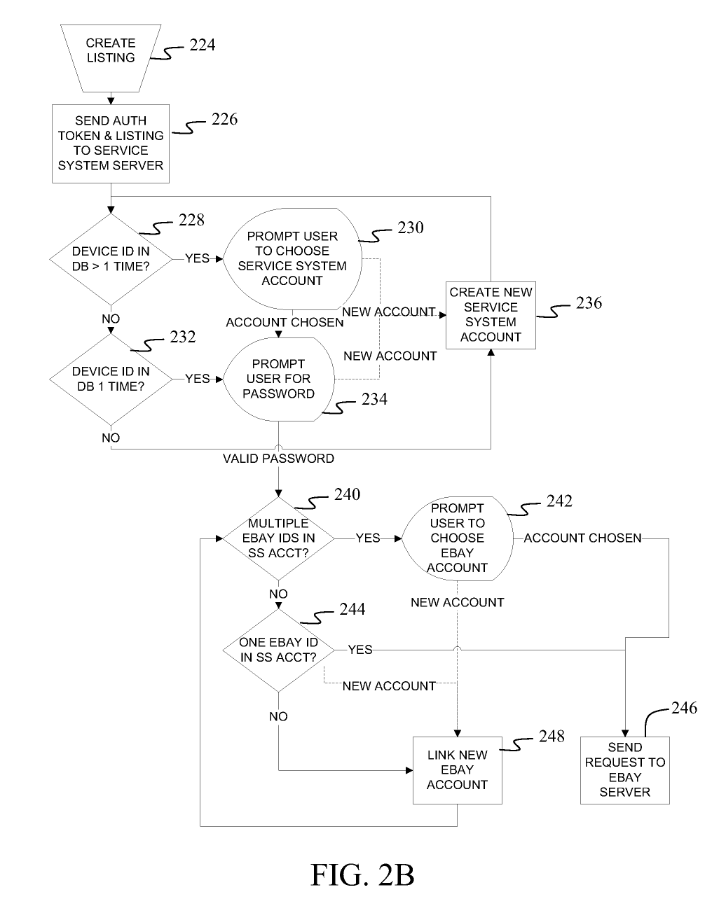

Referring to FIG. 2A, the Registration and Installation Process 110 includes downloading of interactive modules to the PDA 100 through a wireless web connection from a service system provider, entry of registration data for the user via the web connection to the service system servers and an activation process for installation of the interactive modules. The registration process begins at block 200. At block 202, a PDA 100, equipped for incorporating the modules described above, is wirelessly connected to a host server for the service system, and registration information is transmitted to the server at block 204 with the server verifying the input at block 206. If invalid input is received, an appropriate message is returned to the PDA and the system returns to block 204 for transmission of registration information. A valid input results in storage of the PDA data at block 208 in a database 210 associated with the service system. An e-mail or similar type of communication is sent by the service system server at block 212 providing access information and the downloadable application software for the system modules. The downloaded application is installed on the PDA at block 214 and the PDA is then enabled for account login at block 216. Upon logging-in to the host, the host will verify the PDA data and application modules and if valid, will provide a validation code at block 218 to be stored in the PDA for future use at block 220. The registration and installation process is then complete. If an invalid input is received upon account login, the host will respond with an error message and return to block 222 for account login.

In addition to initial registration and downloading of the software system to the PDA, FIG. 2B demonstrates an exemplary process for registration of accounts in the system. Upon entering the system to create a listing at block 224, the PDA sends an authorization token and listing request to the server at block 226. The server determines if a device ID exists in the service system database (DB) at more than one location at decision block 228. If so, the user is prompted on the PDA display to choose the appropriate account relating to that device ID at block 230. If the device ID only exists once in the service system database at decision block 232 or upon selection of the desired account, the user is prompted on the PDA display to enter a password at block 234. If the device ID does not exist in the service system database, a new account is created at block 236 as previously described in blocks 218 through 222 of FIG. 2A. Upon entry of a valid password by the user, a determination is made if multiple account IDs for the selected listing service, such as eBay, Amazon, or Craigslist are present at decision block 240. If so, the system directs the PDA to display a prompt for the user to choose one of the accounts at block 242. If multiple account IDs do not exist for the listing service, a determination is made if one ID exists at decision block 244. If one ID exists or upon choice of the desired account by the user responsive to the prompt at block 242, the service system forwards the listing request to the listing server at block 246 (an E-bay server in the drawing example). If no listing service ID is present, a link is created to the listing service for creation of a new account at block 248. At the prompt for either block 242 or block 244 the user has an option of creating a new account.

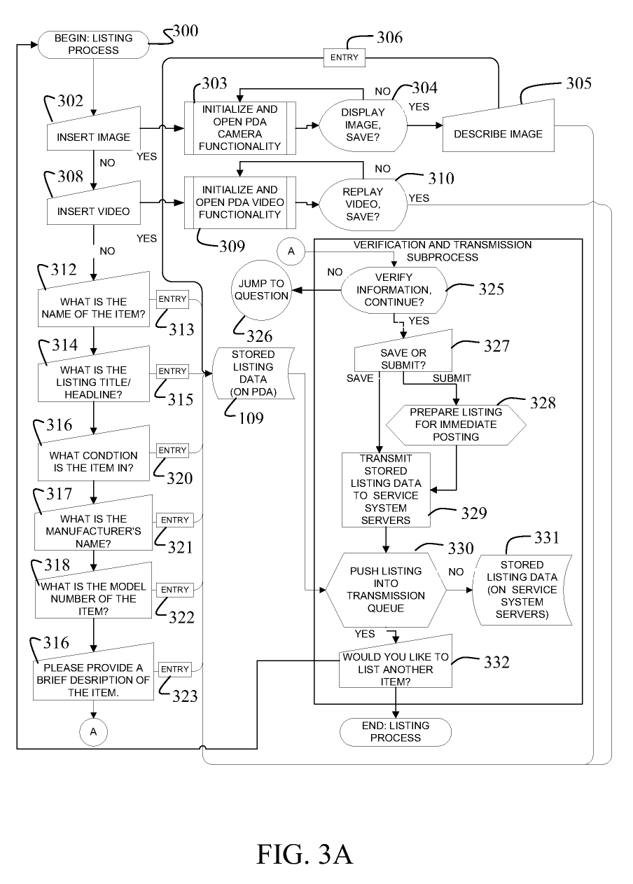

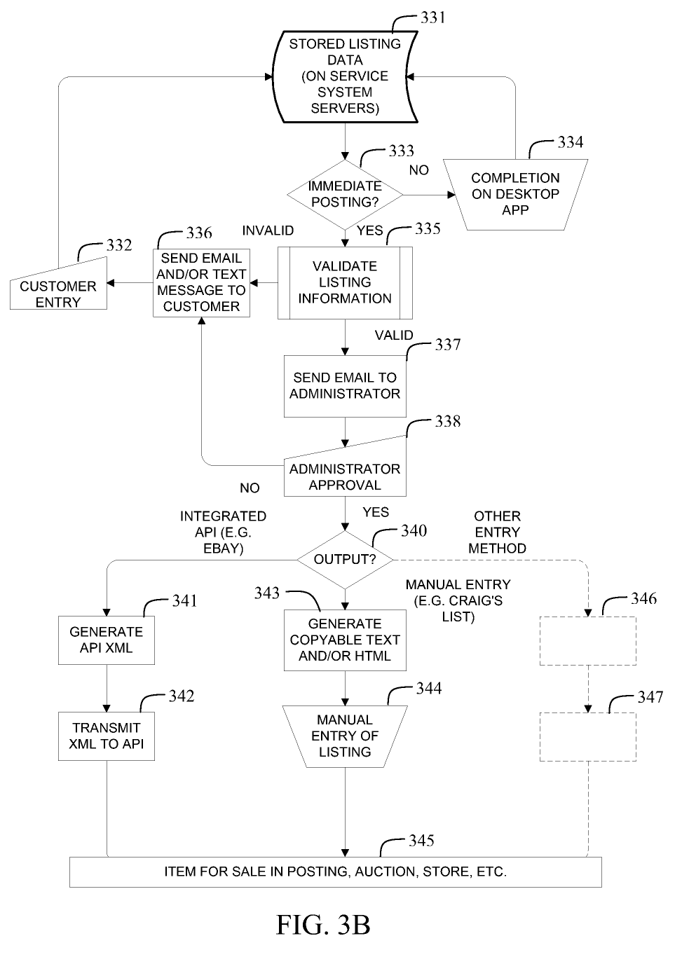

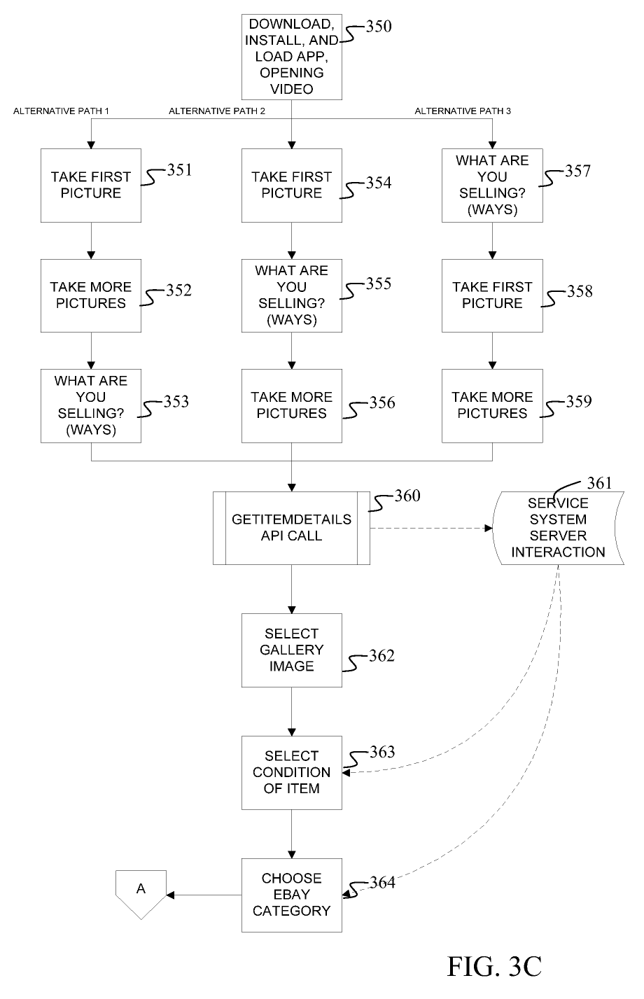

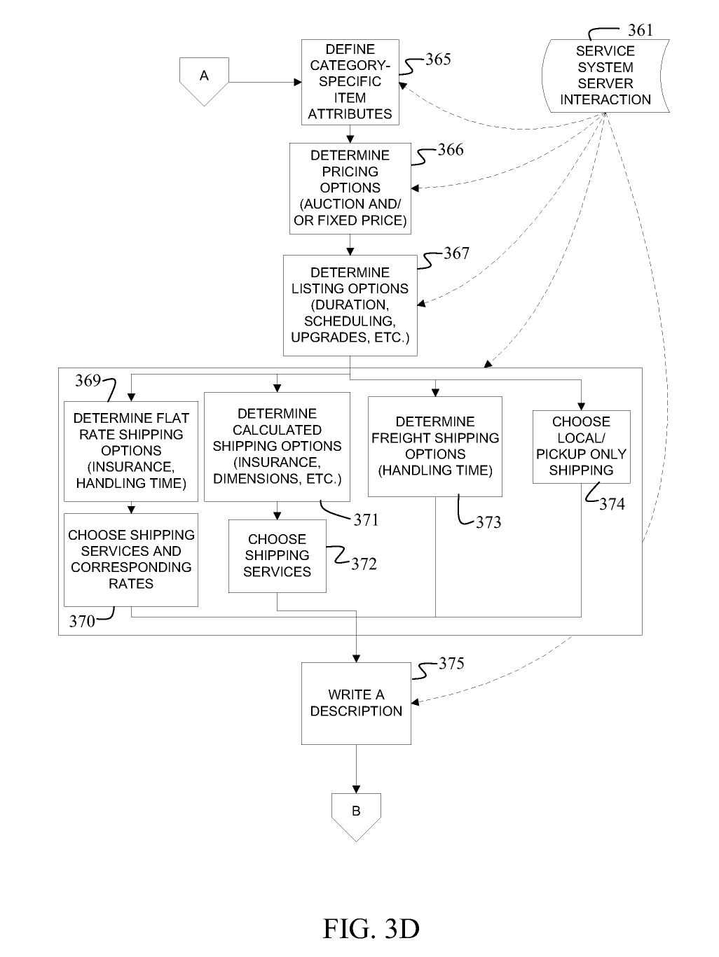

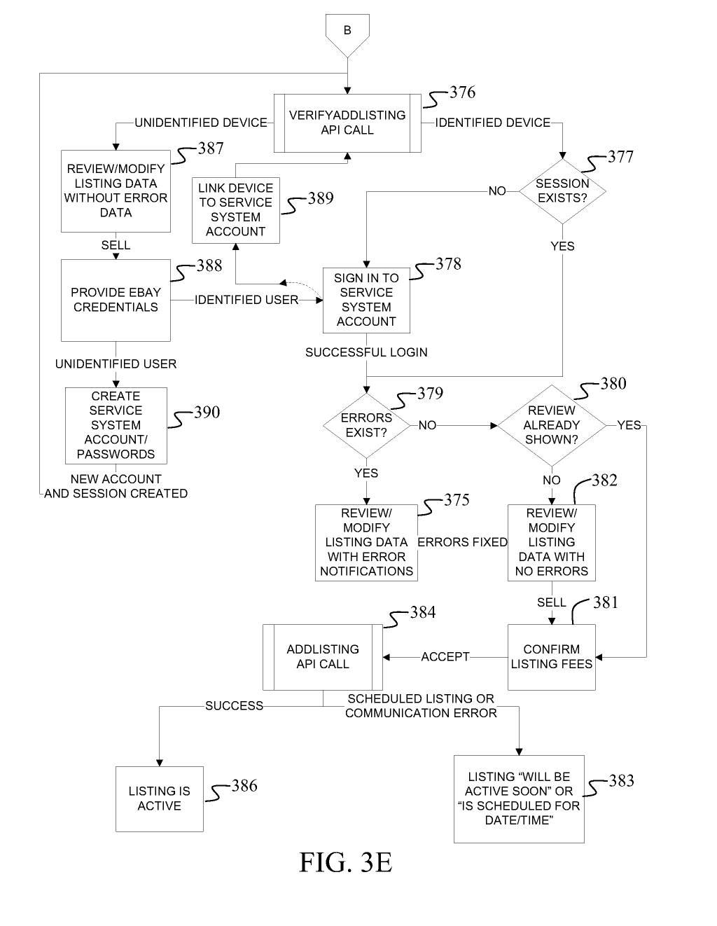

The Listing Process for a first embodiment, shown in detail in FIG. 3A, includes a plurality of routines prompted by the interactive modules on the PDA which can be accomplished prior to entry into the service system server for listing of a sale item to save time and minimize wireless connection time issues. Commencement of the listing process 300 on the PDA is prompted by a request for photo entry at block 302. Using an integrated camera in the PDA or cell phone, the PDA initializes and opens the camera functionality at block 303. The image taken by the user is displayed and a prompt to save the image is provided at block 304. If the image is not sufficient or accepted by the user, the user may select not to save the image and the PDA reverts to the camera mode. If the user saves the image, a prompt is provided for a description of the image at block 305 which is then entered at block 306 on the PDA keypad and a return to the prompt for images is made. Each entry such as block 306 and those subsequently defined are stored on the PDA as listing data as will be described in detail below.

A prompt for video input is then made at block 308 and if selected, the PDA initializes and opens the PDA video functionality at block 309. Upon completion of video input, a prompt for viewing and saving the video is provided at block 310. If not saved, the system reverts to the video input prompt. If saved by entry 311, the data input for the item is stored in the PDA. Multiple items may be prepared for listing and stored on the PDA.

The system then prompts the user for an item name at block 312 which is entered at block 313 using the PDA keypad. A listing title or headline (which may be prompted in a specific format for predetermined sales service providers (i.e. E-bay)) is requested at block 314 and entered at block 315. The item condition at block 316, manufacturer at block 317, model number at block 318 and item description at block 319 are requested with PDA inputs by the user reflected at blocks 320, 321, 322 and 323. Each entry stores data in the memory 109 of the PDA.

A verification and transmission process module at block 324 is activated when the user elects to transmit data to the sales service provider which allows a data review and communicates with the provider (including selection of provider in certain embodiments). A verification routine at block 325 allows the user to scroll through the information input in the listing process and, if a data change is required, allows jumping at branch 326 to the entry question (blocks 312, 314, 316, 317, 318 and 319) for correction/entry. The user is then prompted to save the listing data to the host at the service provider or submit the listing at block 327. The data save to the host allows further processing by the user from a companion desktop application at a personal computer or other network device if more convenient. If a “submit listing” choice is made, the system prepares the listing for immediate posting at block 328. After the listing preparation or if storage on the service system server has been selected, a transmission module at block 329 is activated. The PDA accomplishes a log-in as previously described with respect to FIG. 2B and the PDA pushes the listing into a transmission queue at block 330 retrieving data from the PDA memory which has received each of the listing inputs. The data for the item is then stored on the service provider host server at block 331.

Companion modules on the service system server receive the item data, perform listing functions and actual listing of the item, and confirm communications to the PDA of the listing and sale monitoring/notification functions. As shown in FIG. 3B, the data stored from the PDA is available on the host server data storage at block 331. If the host determines that immediate posting was not selected by the user at block 333, the host module makes the data available for interaction with a PC or other network terminal available to the user for completion of the listing at block 334. If posting has been directed, the host validates the listing information at block 335, and if invalid, generates an e-mail and/or text message to the user at block 336, which is received by the PDA. User input from the PDA through the verification routine previously described provides revised data in the stored data listing for processing. A valid listing results in an e-mail or similar type of communication to the service system server administrator at block 337 for approval of the posting at block 338. If posting is not approved, the service system server reverts to block 336 sending an e-mail or similar type of notification to the user. If the posting is approved, an output will be made at block 340, and a service provider host with an integrated API will generate an appropriate XML for the API at block 341 and transmit the XML to the API for operation at block 342. Alternatively, the service provider administrator will generate copyable text and/or HTML at block 343 and provide manual entry of the listing at block 344. The item posted will then be shown in the service providers, posting, auction or store at block 345. Alternative listing service data entry protocols represented generically as blocks 346 and 347 may be accommodated.

An alternative embodiment for the listing process is shown in FIGS. 3C through 3E. The software download, installation and initiation at block 350 is accomplished as previously described. Upon opening the listing application on the PDA three optional paths are available to the user. In the first alternative path, a prompt is provided on the screen requesting the user to take a first picture. Upon entry of the image at block 351, a prompt is provided on the screen for additional pictures. If the user takes additional pictures, images are entered at block 352, and a prompt is provided on the screen for “what are you selling” (WAYS) with entry of an item title by the user at block 353. In the second alternative path entry of a first image, block 354 results in a prompt for WAYS with entry of an item title by the user, block 355. A prompt is then provided on the screen for additional pictures and additional images are entered at block 356. In the third alternative, the WAYS is prompted on the screen and entered by the user at block 357. A prompt for a first picture is then provided with entry of the image taken by the user at block 358. A prompt for additional pictures is provided on the screen and, if the user takes additional pictures, images are entered at block 359.

The PDA then establishes wireless contact with the service system provider host at block 360 to commence the listing interaction. The service system provides interactive analysis and processing of the various listing input parameters to provide automated assistance where applicable at block 361. A gallery of the images entered for the listing is then presented to the user and a selection of the desired image is made at block 362. A prompt is then provided to select the condition of the item and a condition entered or selected by the user is stored at block 363. A prompt is then provided to select a category for the listed item consistent with the listing service to be used and the chosen category is entered at block 364.

A prompt is then made to define category specific item attributes which are then entered as defined by the user at block 365. Based on the listing service to be used, a determination of pricing options, such as auction or fixed-price, is made at block 366, and listing options such as the duration of the auction, scheduling time for the auction and other listing service features are determined at block 367. For listing services where multiple shipping options are provided, screen prompts and data entry are accomplished, generally designated at block 368. For an exemplary listing service, a determination is made regarding flat rate shipping options such as insurance and handling time at block 369 and the shipping services and corresponding rates are then chosen at block 370. As a first alternative calculated shipping options are determined at block 371, and the appropriate shipping service is chosen at block 372. As a second alternative a determination is made regarding freight shipping options at block 373, and in the fourth alternative local pickup is selected at block 374.

A description is then written for the listed item at block 375, which incorporates the information entered in the interactive listing process on the PDA as set forth above. The description may be a compilation of the entries as entered or may be tailored by interactive operation with the service system's server. A review of the description by the user interactive alteration of the various inputs or recommendations may then be accomplished.

As a continuation of the listing process, or as a subsequent wireless contact, the PDA calls the service system provider host for verification of the ad listing at block 376. If upon the call the provider host recognizes the PDA as an identified device, a determination is made if a wireless session exists at block 377. If a session does not exist signing in to the service system account at block 378 is accomplished as previously described. Upon a successful log in or if a prior session did exist, a determination is made if errors in the listing are present at block 379. A determination is then made if a review of the listing by the user has been made on the PDA at block 380. If the listing has been reviewed by the user, a confirmation of listing fees to be charged by the sales listing service is made at block 381.

If the user has not yet reviewed the listing, data for the review is provided on the PDA screen at block 382, and if no errors are identified or changes made by the user as designated by a “sell” instruction, the listing fees are then confirmed. Similarly, if errors do exist in the listing as detected by the provider host, listing data for a review with error notifications is presented to the user at block 383. Entries by the user to fix the identified errors results in presentation of the listing data as previously defined for block 382.

Upon acceptance of the listing fees the provider host issues a listing call to the listing service server at block 384. A successful interaction between the provider host server and the listing service server results in an active listing at block 385. If the listing is subsequently to be scheduled or a communications error occurs between the service provider host and listing service server, notification is provided to the user on the PDA screen at block 386.

If the device is unidentified during the verify add listing call of block 376, a data review for the listing is presented at block 387, and upon a sell command from the user listing, service credentials are provided at block 388. An identified user is then signed into the service system account as previously defined in block 376 and the device is linked to the service system account at block 389. If the user remains unidentified, a service system account is created at block 390, and the new account and session are created.

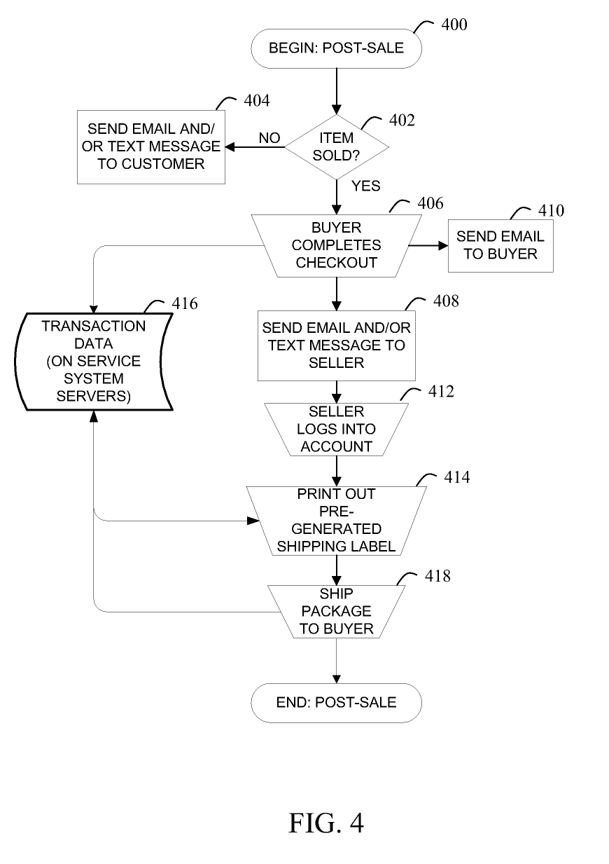

The Post Sale Process 400 shown in FIG. 4 employs the companion modules at the service provider host to monitor the posting for sale at block 402. If the item is not sold, the host sends a text message or email notification to the PDA notifying the user at block 404. If the item is sold, and the buyer completes the internal checkout processes of the provider at block 406, the host sends a text message or email notification to the PDA of the sale at block 408. Standard host processing for notification of the buyer through e-mail is also accomplished at block 410 and the transaction data for delivery is stored at the host at block 412. Upon receipt of the “sale” message, the PDA system then provides automated interactive modules to the user to log into the account at block 412 for shipping instructions and printing out a pre-generated shipping label at block 414 through interaction with the transaction data at block 416 saved on the host data storage system. Upon shipment of the package to the buyer, the PDA system is used to transmit a shipment notice at block 418 to the host for storage on the host data system and post sale requirements.

A system employing the present application is compatible with advanced PDAs and cellular phones which preferably provide, as described previously with respect to FIG. 1A, a touch sensitive screen 106 and standard cursor controls 107 for manipulating data on the screen. A keypad 104 for data entry provides input for the various text elements required by the system. In alternative embodiments, use of stylus written input using systems such as Palm® Graffiti or a keyboard image on the screen and with touch activation may be employed.

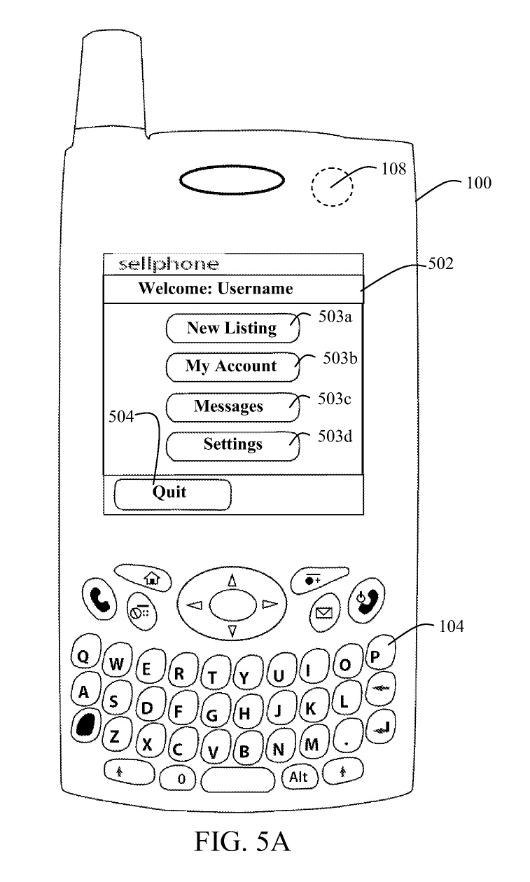

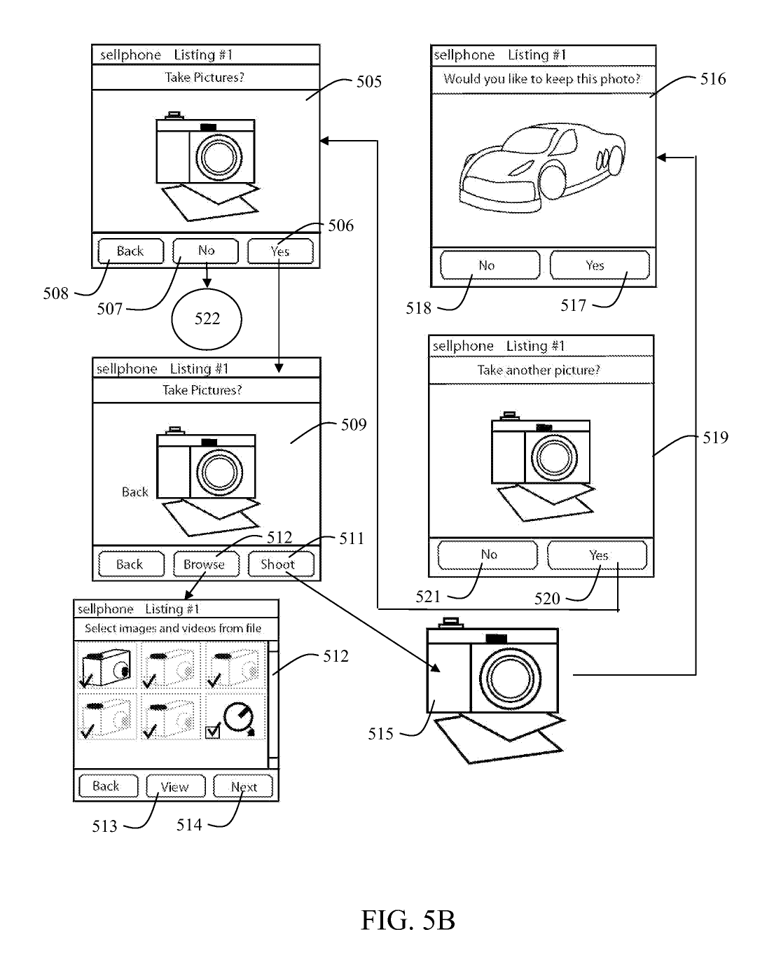

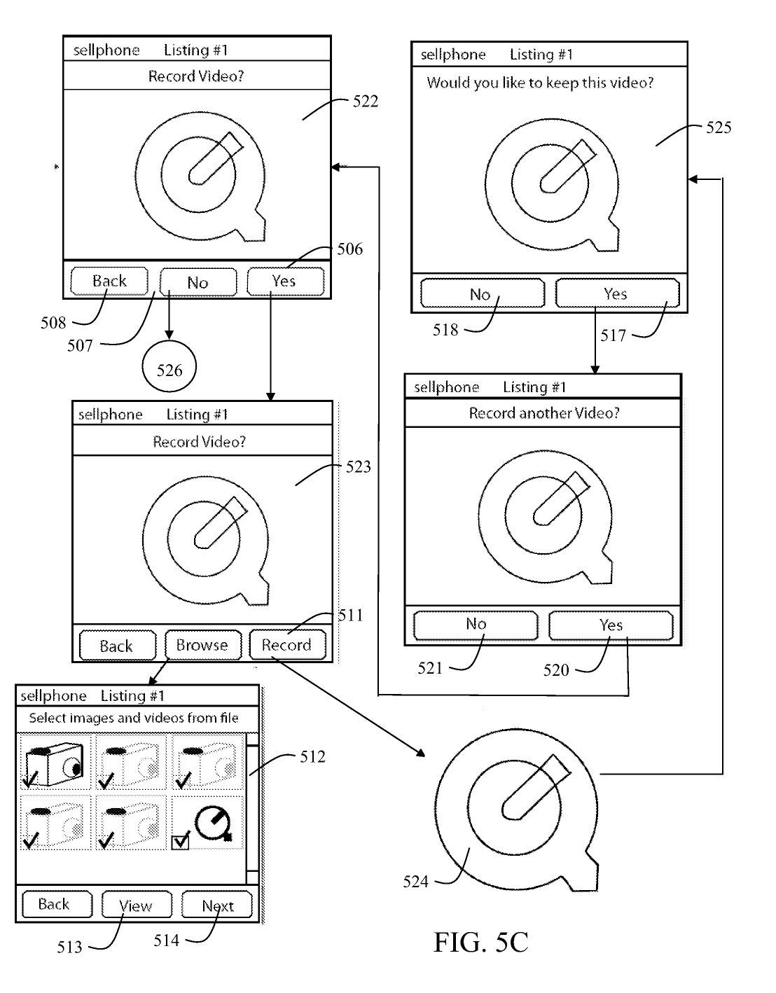

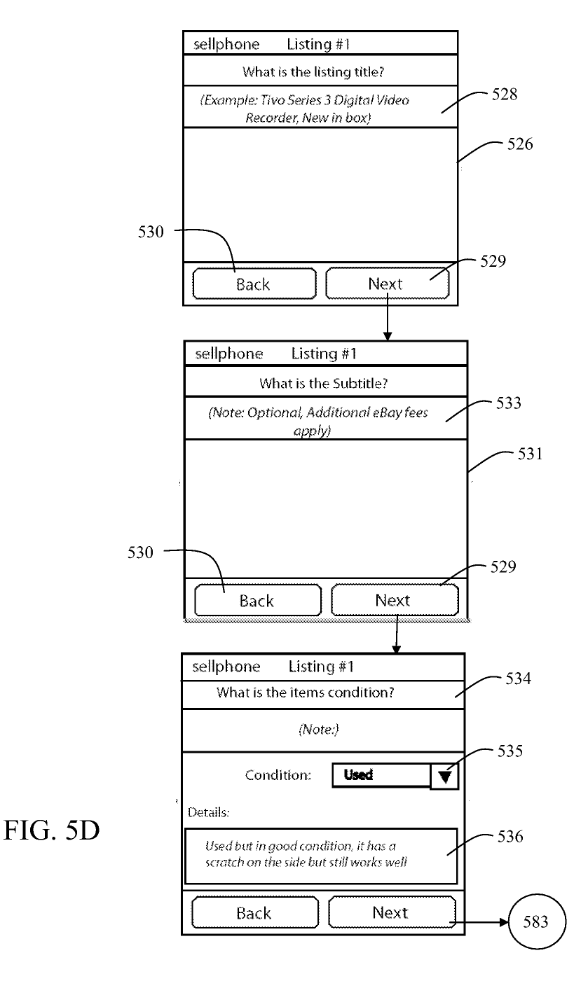

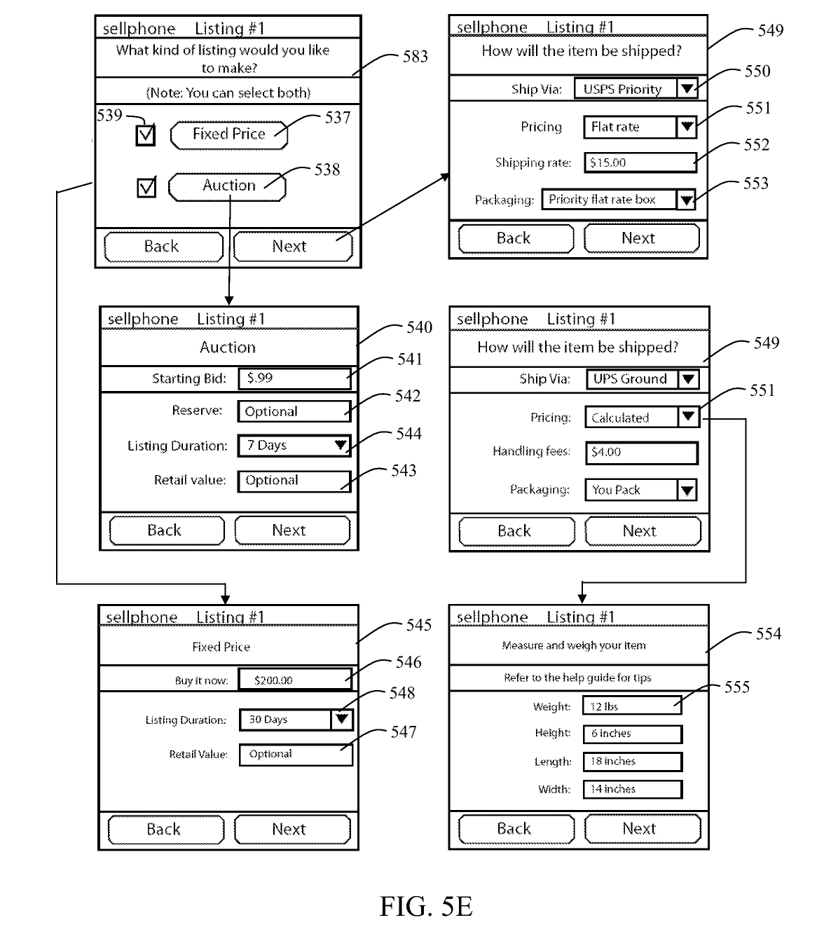

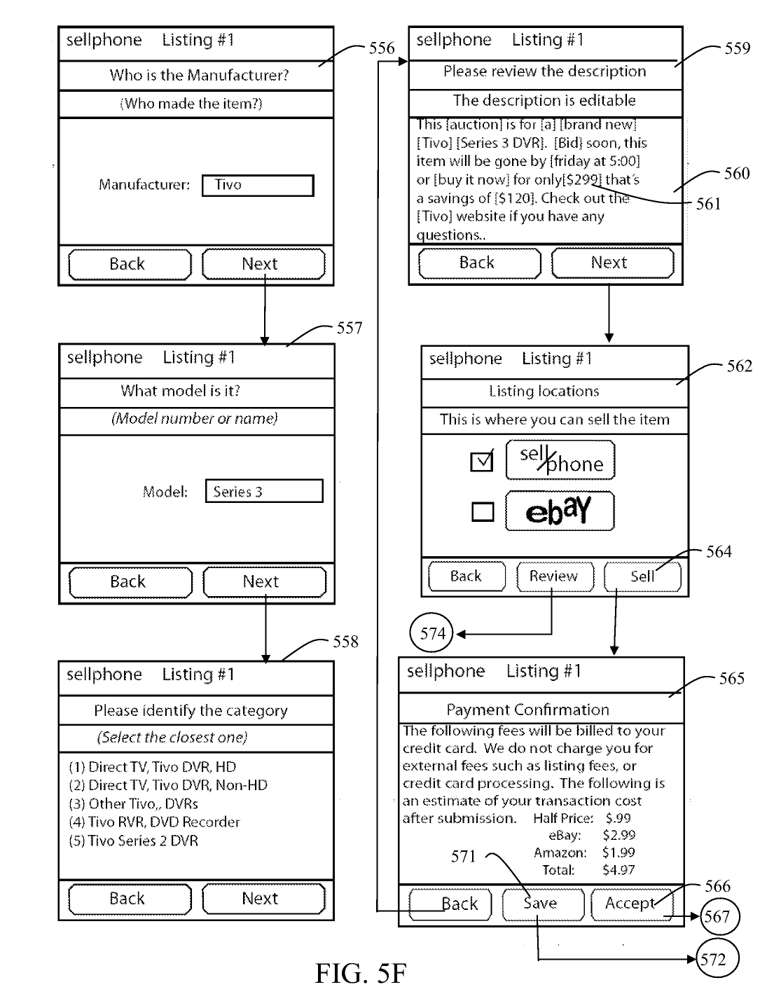

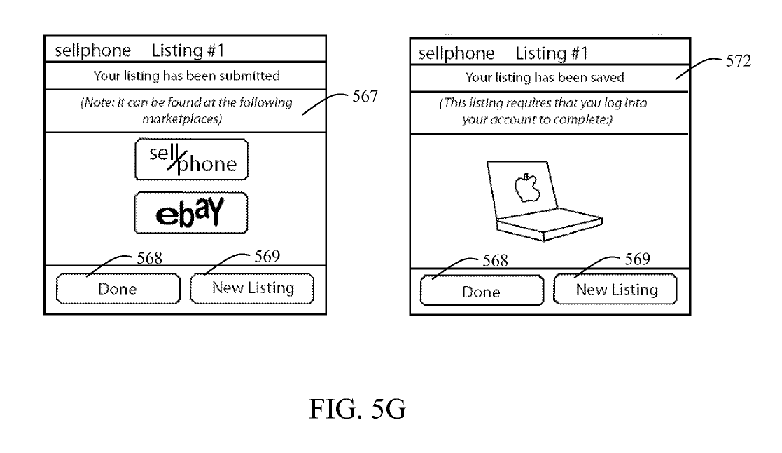

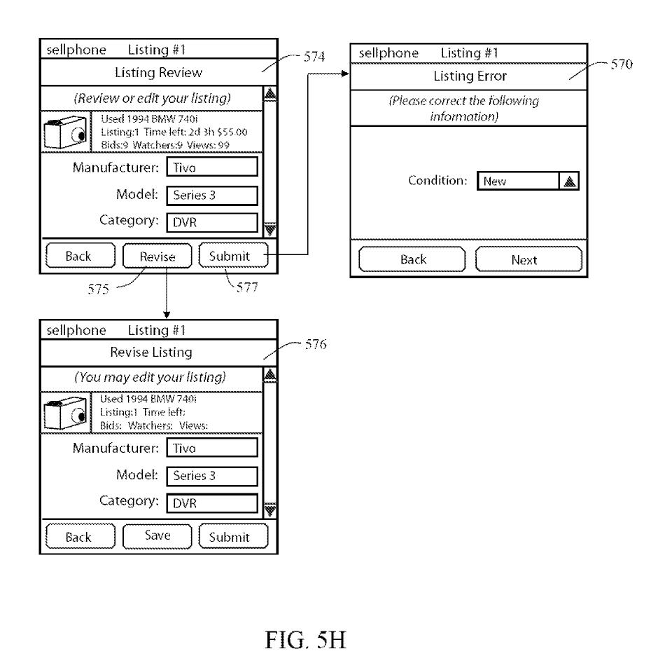

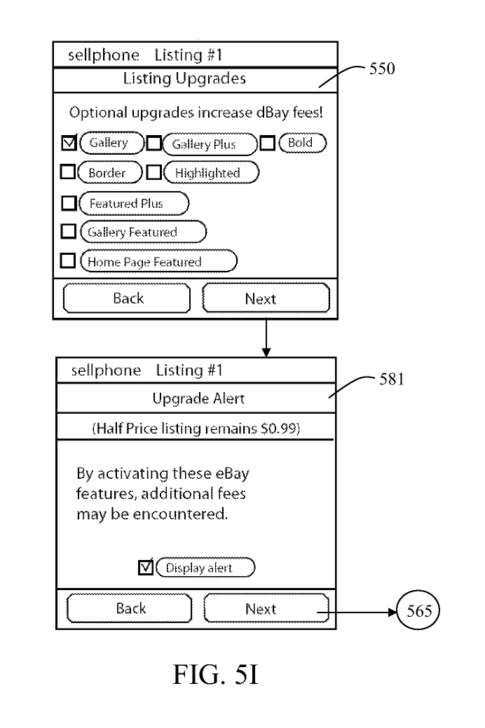

An exemplary embodiment of the inventive system, employed on an advanced PDA/Cellular Phone such as a Palm® Treo™ Smart Phone with touch screen capability activated by contact of the user's finger or a stylus (referred to herein as “touching”), is shown with interactive screen shots for the PDA using processes described in FIGS. 5A through 5I, 6A through 6C and 7A through 7D. Referring to FIGS. 5A through 5I, the system display for the exemplary embodiment provides a welcome screen 502 when initialized. The initial screen includes multiple interactive buttons for selection of available functions such as new listing 503a, my account 503b, messages 503c, and settings 503d. A quit button 504 allows for exiting the program. Touching the new listing button brings up a photo entry screen 505 as shown in FIG. 5B. The screen provides buttons for function selections: a yes button 506 to engage the camera function or a no button 507 to advance to the next screen. A back button 508 is provided to return to the listing text element screens. If the yes button is touched, a photo selection screen 509 is presented providing the option to select a photo from memory with a browse button 510 or capture a new image with a shoot button 511. Touching browse brings up an image memory screen 512 displaying icons for photos and video available in memory on the PDA. A view button 513 allows a selected image/video to be viewed and a next button 514 allows the image to be entered as the selected photo for the listing.

Alternatively, if a new photograph is desired, touching the shoot button on the photo entry screen initializes the internal camera function of the PDA allowing normal image capture represented by icon 515. The image is then displayed in a photo confirmation screen 516 which prompts the user to accept the image with a yes button 517 or reject it with a no button 518. A no selection deletes the image. A yes selection stores the image and brings up an additional photo selection screen 519 which provides a yes button 520 and a no button 521. A yes selection returns to the image capture sequence. A selection of the no button enters the image or images taken into the listing and advances to a record video option screen 522 providing a selection sequence for video comparable to the photo selection having video selection screen 523 with access to the image memory through screen 512 or activation of the internal video capture capability of the PDA 524, video confirmation 525 is provided having similar functionality to the image screen 516 as previously described. Upon completion of the image entry routines, a listing title screen 526 is presented which prompts the user to enter a title for the listing in a text entry block 527. For the embodiment shown an example block 528 provides additional assistance to the user. Next 529 and back 530 buttons are provided to advance after entry of the title or return to the welcome screen.

Touching next after entering the title brings up a subtitle screen 531 for optional entry of a subtitle in text entry block 532. As with the title entry screen, an example prompt 533 is provided which also may include information on system requirements or interaction such as the requirement for additional fees to enter a subtitle in the sales provider's system. Next 529 and back 530 buttons are again displayed for exiting the screen. Touching next brings up a condition screen 534 for entry of information on condition of the sale item. For the embodiment shown, a drop down box 535 with predetermined condition definitions is provided as well as a text entry box 536 for detail description. The condition entry screen is exemplary of the data input screens available for the system which are tailored for interface between the service provider system and the PDA. As will be described below, the PDA may initially prompt for a service provider definition prior to commencing the new listing process which will select and sequence the input screens based on the data available or required for listings on that service provider's system.

Upon completion of the text entry elements of the listing, touching next brings up a sales type option screen 583. Consistent with most current sales service provider systems, a fixed price button 537 and an auction button 538 are provided. For the embodiment shown, a check box 539 is associated with each sale type for selection. Touching the auction button launches an auction screen 540 providing text entry blocks for starting bid 541, reserve 542 and retail value 543 with a drop down box 544 with preselected auction periods. Similarly, pressing the fixed price button launches a fixed price sale screen 545 with text entry blocks for “Buy It Now” pricing 546 and retail value 547 and a drop down box 548 with preselected sales periods.

Completing or skipping the sales type screens, a shipment selection screen 549 is launched providing drop down boxes for shipment carrier 550 and pricing 551, which for the embodiment shown allows either fixed rate or calculated. A fixed rate selection allows entry of a shipping rate in text box 552. A packaging type drop down selection 553 is also provided. A selection of “calculated” in the drop box as shown in shipment selection screen 549 brings up a screen 554 for entry of shipping data such as weight and dimensions in text entry boxes 555.

Continuing with FIG. 5F, additional item information screens such as manufacturer screen 556 and model number screen 557 provide text boxes for entry of data. For commonly offered manufacturers, the system will provide preloaded data which is presented in additional screens such as the category selection screen 558 for selection by the user to supplement entered data. A final listing description is displayed in a review screen 559 with scroll bars 560 allowing the user to verify data as entered and as will be presented to the sales system provider for uploading and presentation to their customers. For the embodiment shown, elements of the description that have been entered are shown in highlighted text 561 and touching the highlighted text will return the user to the entry screen for that element to allow revision or correction.

Data for the created listing is now complete in the PDA based system. A listing location screen 562 is then presented to the user identifying the various sales service providers with which the PDA has been registered as previously described. Selection boxes 563 allow one or more listing services to be employed. A sell button 564 is provided for connection with the selected sales service provider. Upon connection and transmission of the listing to the provider, a payment confirmation screen 565 is presented with option buttons. In the exemplary embodiment shown, the confirmation screen provides cost information for the listing. An accept button 566 allows the user to accept the costs and enter the listing on the service. If the listing is error free, a submission success screen 567 is presented. On the exemplary screen, the user may then select a done button 568 to exit the system or a new listing button 569 for selection of an additional listing for entry from titles of saved entries.

If an error is identified in an attempted submission, a listing error identification screen 570 is presented identifying to the user that an error exists and requiring correction through logging on to the sales service provider's system via an internet terminal. This screen then gives the user option buttons for done or a new listing selection.

As an alternative to accepting the entry of the listing on the service, a save button 571 on the payment confirmation screen allows the user to store the listing data with the sales service provider for future access. If this option is selected, a data saved confirmation screen 572 is presented which again provides done or new listing selection buttons.

At the listing location screen 562 a review button 573 is also provided to allow the user additional options prior to entry of the listing with a sales service provider. If a single service provider has been selected, selection of the review button prompts a listing review screen 574 allowing the user to review all elements of the listing. A revise button 575 allows the user to access the various data entry screens through a revise listing screen 576. A submit button 577 is selectable to create an automated review of the listing. If successful, the listing locations screen is presented again. If an error is detected, a listing error screen 570 is presented which identifies the error and allows correction. Upon correction, the listing location screen is again presented to allow a sell button selection. A save button 571 is provided to allow the listing to be saved in the PDA memory.

At the listing location screen 562, if multiple sales service providers are selected as represented in the listing location screen as shown, options for the service providers are presented responsive to a next button selection in listing upgrade screens 580 providing various entry options. For the embodiment shown, warning screens 581 are presented if selection of entry options results in additional cost. Selection of the desired options and selection of a next button and/or acknowledgement of the warning screens by selection the next button results in submission of the listing to the service provider with presentation of the payment confirmation screen.

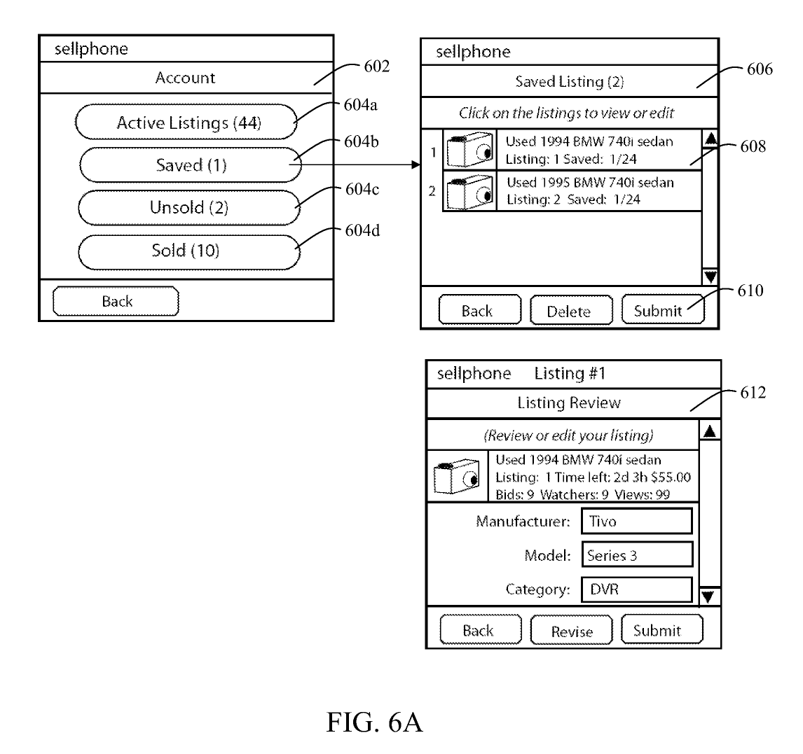

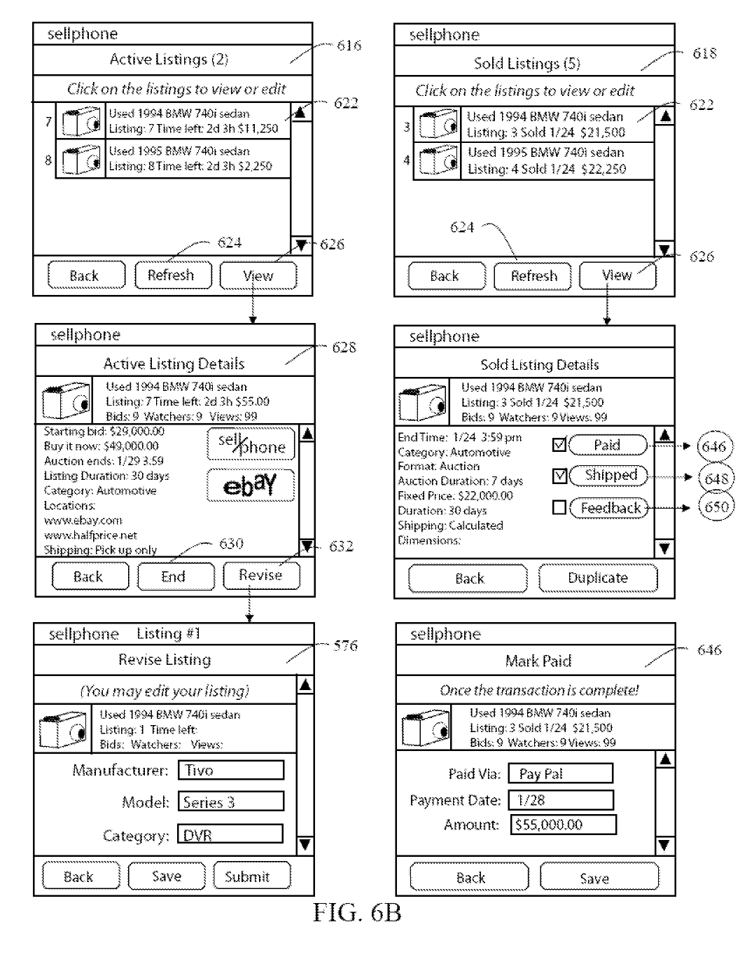

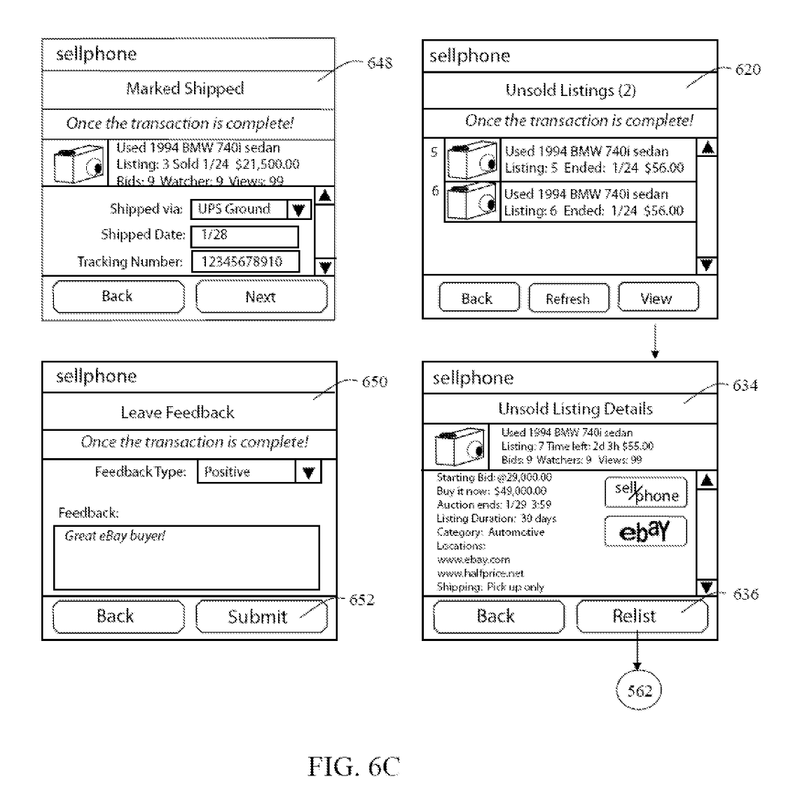

As previously identified with respect to the welcome screen 502 presented to the user upon initializing the system on the PDA, additional capability is provided as shown in FIGS. 6A through 6C for account maintenance upon touching of the my account button 504b. An account screen 602 is presented with option buttons for review of saved listings 604a, active listings 604b, unsold listing 604c and sold listing 604d.

Selection of the saved listings button launches a saved listing screen 606 which provides identifiers 608 for each listing save in the PDA memory. An “edit” button 610 is provided for selection by the user to produce a listing review screen 612 of a selected listing with the features previously described to revise or submit the listing. Alternatively, a delete button 614 is provided to allow deletion of a selected entry.

The active listing, unsold, and sold selection buttons for the account screen provide information on listings previously submitted and prompt information and response screens based on interactions typically required with the sales service providers. Touching the respective buttons results in presentation of an active listing screen 616, a sold listings screen 618 or an unsold listings screen 620 respectively. Each of these screens provides identifiers 622 for each listing in that category, a refresh button 624 for connection to the service provider to update the status of the listings and a view button 626 to view the listing for a selected identifier.

For the active listings, responsive to the view button for a selected identifier, a details screen 628 is presented with all elements of the listing and the transaction status with the sales service provider's system. An end button 630 is provided to terminate the listing. A revise button 632 is provided to launch a revise listing screen 576 with functionality as previously described.

For unsold listings, responsive to the view button for a selected identifier, an unsold listing details screen 634 is presented showing the details of the listing and providing a relist button 636 which when touched transitions that listing to the listing locations screen 562 for reprocessing.

Finally, for sold listings, responsive to the view button for a selected identifier, a sold listing details screen 638 is launched which details the listing and provides buttons for designating paid 640, shipped 642 and feedback 644. Each of these buttons launches one of three respective screens; mark paid 646, mark shipped 648, and leave feedback 650 which allow entry of details regarding that function as text and/or drop down boxes. The leave feedback screen, in turn, has a submit button 652 allowing text feed back entered on the screen to be submitted to the buyer through the sales service provider system.

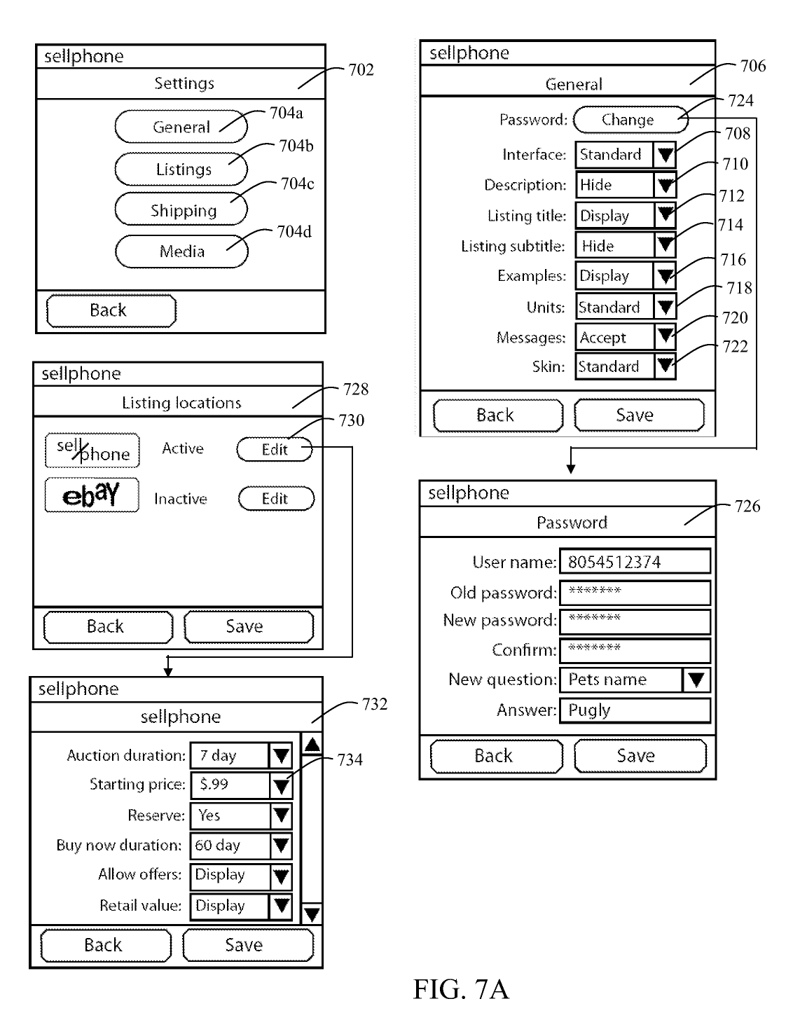

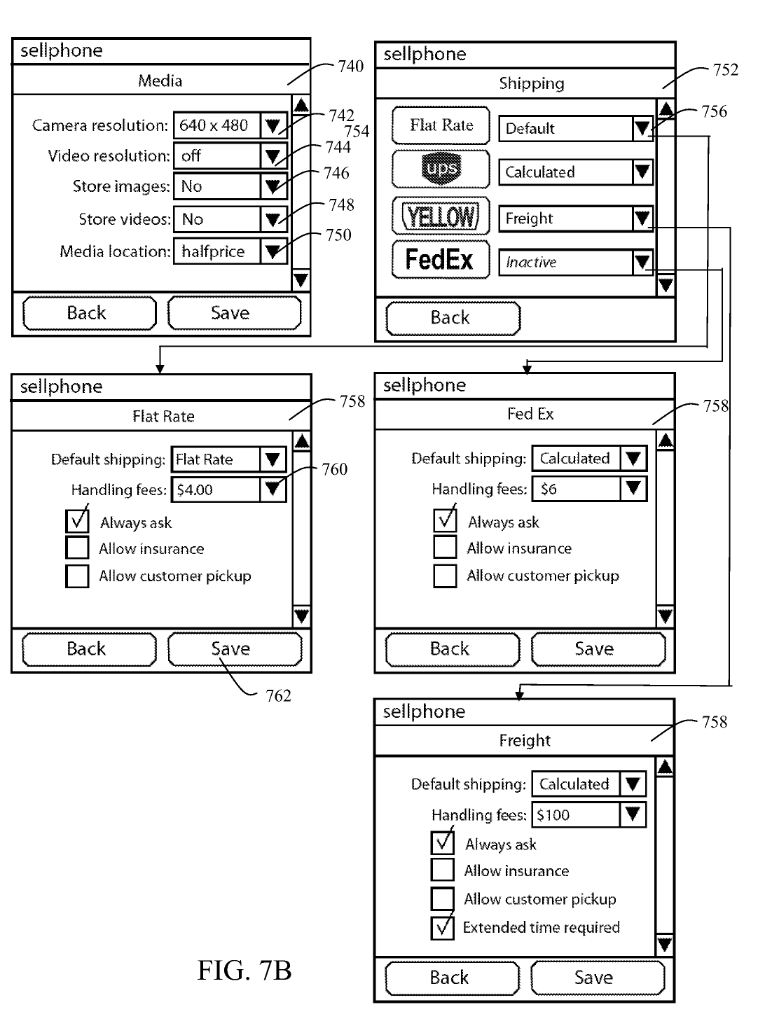

Returning to FIG. 5A, selection of the settings button 504d on the welcome screen launches a settings screen 702, as shown in FIGS. 7A and 7B, which provides for entry and selection of preferences for system elements. A “general” button 704a launches a general preferences screen 706 which identifies and provides for modification of system preferences such as, for the exemplary embodiment shown, interface with the sales service provider's system using a drop down box 708 for preselected interface options. An ability to hide or show the description of listings is provided with a drop down box 710, listing title with drop down box 712, listing subtitle with dropdown box 714 and examples with drop down box 716. A selection of units of measure for the shipping and other system functions is provided in drop down box 718. Enabling or disabling message communication with the PDA by the sales service providers is established using drop down box 720. A “skin” or screen appearance is provided via drop down box 722. A button to change password 724 launches a password screen 726 which allows entry of password information and verification data.

A listings button 704b on the settings screen launches a listing locations screen 728 which identifies the sales service providers with which the PDA system is registered. The listing locations screen allows selection of and identifies the status of each provider as active or inactive and provides edit buttons 730 for modification of general data inputs specifically associated with each provider. As exemplary, provider screen 732 incorporates drop down boxes 734 for selection of default values for such values as auction duration, auto re-list, starting bid, reserve, make offer, retail value, subtitles, picture options, picture show, Gallery options and Text options. Similarly, alternate provider screens provide similar selection capability for each alternative provider.

A media button 704d on the settings screen launches a media options screen 740 which allows selection of properties for media to be used in association with the listing including camera resolution with a drop down box 742 and video resolution with drop down box 744 to allow the user to maximize storage. An option to store or not store images or video generated during development of listings is provided in drop down boxes 746 and 748. If media is not permanently stored on the PDA, transfer of the listing data generated in the listing process previously described will result in deletion of the associated media files for that listing in the PDA memory. For a sales provider with which media storage is provided with listings, a drop down box 750 for identification of that provider is available.

Finally on the settings screen a shipping button 704c is provided to launch a shipping screen 752. The shipping screen incorporates selectable identifiers 754 for multiple shipping entities with drop down boxes 756 for selection of shipping types assigned. Selection of the identifier for any shipping entity launches an entity screen 758 which provides detail information selectable by dropdown boxes 760 for shipping alternatives to be presented as a portion of prepared listing.

In each of the preferences screens a save button 762 is provided to save changes to the preferences entered on the screen.

In accordance with one aspect of the present application, a computer-implemented method for listing an entry on an online auction or sale service using a wireless communications device is presented. The method includes obtaining image data and creating an image of an item using the image data. In addition, the method includes displaying the image and determining if the image is acceptable and, if affirmative, saving the image. Upon saving the image, the method includes requesting and receiving descriptive data for the item and storing the descriptive data and image data as a listing. Furthermore, the method includes submitting the listing wirelessly to a provider host.

The computer-implemented method as described above wherein the step of requesting and receiving descriptive data includes item image name, listing title and identifying data. The computer-implemented method as described above wherein identifying data includes item condition, manufacturer, model number and item description.

In accordance with another aspect of the present application, a wireless computer system having a camera and a display screen with touchpad capabilities for implementing a method for listing services or goods on a host server using the display screen is presented. The method includes receiving an image from the camera, the image associated with the service or good, and displaying the image on the display screen, the image capable of being accepted through the display screen with touchpad capabilities. In addition, the method includes saving the image when the image is accepted through the display screen with touchpad capabilities and requesting and receiving descriptive data for the image associated with the service or good, the descriptive data and image stored as a listing. Furthermore, the method includes transmitting the listing wirelessly to the host server.

In accordance with yet another aspect of the present application, a wireless device is presented. The wireless device includes a camera, at least one processor, a graphical user interface (GUI), and a memory operatively coupled to the processor, the memory storing program instructions that when executed by the processor, causes the processor to perform a plurality of processes. The instruction, when executed, cause the processor to receive an image from the camera, the image associated with an item, and display the image on the GUI, the image capable of being accepted through the GUI. In addition, the instructions, when executed, cause the processor to request and receive descriptive data for the image associated with the item when the image has been accepted through the GUI and store the descriptive data and image as a listing. Furthermore, the instructions, when executed, cause the processor to transmit the listing wirelessly to a host server.

In accordance with another aspect of the present application, a computer program product for a user computer system including a processor, a display, a user input device, and a camera for listing an item on a host server is presented. The computer program product included in a computer-readable memory has code that directs the processor to install components on the system. In addition, the computer program product has code that directs the processor to receive an image from the camera and descriptive data associated with the item for generating the listing and transmit and verify the listing to the host server. Furthermore, the computer program product has code that directs the processor to notify the user of the listing.

In accordance with still yet another aspect of the present application, a computer-implemented method for listing an item for sale is presented. The method includes requesting entry of image data using a wireless communication device and initiating an integrated camera mode in the device to create an image of an item. In addition, the method includes displaying the image and determining if the image is acceptable and, if affirmative, saving the image. Furthermore, the method includes requesting and receiving descriptive data for the item and storing the descriptive data and image data on the device as a listing. The method also includes submitting the listing wirelessly through the device to a provider host.

The computer-implemented method wherein the step of requesting and receiving descriptive data for the item includes requesting an image description and accepting entry of a description of the image on the keypad. In addition, the method includes requesting an item name on a display of a wireless device and accepting entry of the name using a keypad on the device. Furthermore, the method includes requesting a listing title and accepting entry of the listing title on the keypad. The method also includes requesting identifying data for the item and accepting entry of the indentifying data on the keypad.

The computer-implemented method disclosed wherein the storing of the descriptive data includes the step of storing item image name, listing title and identifying data. The computer-implemented method disclosed wherein the identifying data includes the item condition, manufacturer, model number and item description.

The computer-implemented method disclosed further including the steps of wirelessly connecting the communications device to the provider host and transmitting registration information from the device to the provider host. In addition, the method includes the steps of verifying the information input at the provider host and if an invalid input is received, returning an appropriate message to the device. Furthermore, the method including the steps of storing the registration information in a database associated with the provider host if a valid input is received and sending an e-mail from the provider host to the device providing access information and downloadable application software modules. The method also including the steps of installing the application software modules on the device and enabling the device for account login.

The computer-implemented method, as disclosed, including the steps of verifying the device registration information and application software modules and providing a validation code to be stored in the device if valid. The step of submitting a listing further includes the initial steps of logging in to the account on the provider host using the validation code and responding with an error message if an invalid input is received upon account login.

In accordance with another aspect of the present application, a system for listing an item on an online auction or sale service is presented. The system includes a network and a wireless communication device for transmitting a listing to the online auction or sale service through the network. The wireless communication device obtains image data of the item from a camera coupled to the wireless communication device, displays the image to a user of the wireless communication device, and if accepted by the user, request and receives descriptive data for the item to generate the listing. In addition, the system includes a provider host for receiving the listing through the network and hosting the online auction or sale service. The provider host receives registration information from the wireless communication device, verifies the information, and if verified, displays the listing on the online auction or sale service provided by the provider host.

In accordance with another aspect of the present application, a server coupled to a network for hosting an online auction or sale service is presented. The server includes at least one processor and memory operatively coupled to the processor, the memory storing program instructions that when executed by the processor, causes the processor to perform a plurality of processes. The program instructions, when executed, cause the processor to receive registration information from at least one wireless communication device through the network and verify the registration information from the at least one wireless communication device. If valid registration information is received, the program instructions, when executed, cause the processor to accept listing information from the at least one wireless communication device, wherein the listing information contains image data and descriptive data of an item to place on the online auction or sale service hosted by the server, the image data taken from a camera coupled to the at least one wireless communication device.

The system of the application can take the form of an entirely hardware embodiment, an entirely software embodiment or an embodiment containing both hardware and software elements. In one embodiment, the system is implemented in software, which includes but is not limited to firmware, resident software, microcode, etc.

Furthermore, the system can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium comprise a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Described above, aspects of the present application are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The internet 20 can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art.

Furthermore, computers and other related electronic devices can be remotely connected to either the LANs or the WAN via a digital communications device, modem and temporary telephone, or a wireless link. It will be appreciated that the internet comprises a vast number of such interconnected networks, computers, and routers.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HTML, or other markup languages, that are electronically stored at or dynamically generated by “WWW sites” or “Web sites” throughout the Internet. Additionally, client-side software programs that communicate over the Web using the TCP/IP protocol are part of the WWW, such as JAVA.™ applets, instant messaging, e-mail, browser plug-ins, Macromedia Flash, chat and others. Other interactive hypertext environments may include proprietary environments such as those provided in America Online or other online service providers, as well as the “wireless Web” provided by various wireless networking providers, especially those in the cellular phone industry. It will be appreciated that the present application could apply in any such interactive communication environments, however, for purposes of discussion, the Web is used as an exemplary interactive hypertext environment with regard to the present application.

A website is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a website elsewhere on the Internet. Each hyperlink is assigned a URL that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs, such as application programs written in the JAVA.™ programming language from Sun Microsystems, for execution on a remote computer. Likewise, a web server may also include facilities for executing scripts and other application programs on the web server itself.

A remote access user may retrieve hypertext documents from the World Wide Web via a web browser program. A web browser, such as Netscape's NAVIGATOR.™ or Microsoft's Internet Explorer, is a software application program for providing a user interface to the WWW. Upon request from the remote access user via the web browser, the web browser requests the desired hypertext document from the appropriate web server using the URL for the document and the hypertext transport protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JAVA applets, for execution on the client computer. Finally, the WWW browser may include optional software components, called plug-ins, that run specialized functionality within the browser.

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the art are expressly incorporated herein by reference and intended to be encompassed by the claims. Moreover, nothing disclosed herein is intended to be dedicated to the public regardless of whether such disclosure is explicitly recited in the claims.

What is claimed is:

1. A computer-implemented method for listing an entry on an online auction or sale service using a wireless communications device, the method comprising:
obtaining image data;
creating an image of an item using the image data;
displaying the image;
determining if the image is acceptable and, if affirmative, saving the image;
upon saving the image, requesting and receiving descriptive data for the item;
storing the descriptive data and image data as a listing; and
submitting the listing wirelessly to a provider host.

2. The computer-implemented method as defined in claim 1 wherein the step of requesting and receiving descriptive data includes item image name, listing title and identifying data.

3. The computer-implemented method as defined in claim 2 wherein identifying data includes item condition, manufacturer, model number and item description.

4. The computer-implemented method as defined in claim 1 wherein the method further comprises installing application software modules on the wireless communication device.

5. The computer-implemented method as defined in claim 4 wherein a module within the application software modules enables the wireless communication device for account login.

6. In a wireless computer system having a camera and a display screen with touchpad capabilities, a method for listing services or goods on a host server using the display screen, the method comprising:
receiving an image from the camera, the image associated with the service or good;
displaying the image on the display screen, the image capable of being accepted through the display screen with touchpad capabilities;
saving the image when the image is accepted through the display screen with touchpad capabilities;
requesting and receiving descriptive data for the image associated with the service or good, the descriptive data and image stored as a listing; and
transmitting the listing wirelessly to the host server.

7. The method for listing services or goods on a host server as defined in claim 6 wherein the step of requesting and receiving descriptive data includes receiving item image name, listing title and identifying data.

8. The method for listing services or goods on a host server as defined in claim 7 wherein identifying data includes item condition, manufacturer, model number and item description.

9. A wireless device comprising:
a camera;
at least one processor;
a graphical user interface (GUI); and
a memory operatively coupled to the processor, the memory storing program instructions that when executed by the processor, causes the processor to:
receive an image from the camera, the image associated with an item;
display the image on the GUI, the image capable of being accepted through the GUI;
request and receive descriptive data for the image associated with the item when the image has been accepted through the GUI;
store the descriptive data and image as a listing; and
transmit the listing wirelessly to a host server.

10. A computer program product for a handheld user computer system including a processor, a display, a user input device, and an integrated camera for listing an item on a host server, the computer program product included in a computer-readable memory and comprising:
code that directs the processor to install components on the system;
code that directs the processor to
receive an image from the integrated camera and descriptive data associated with the item for generating the listing;
transmit and verify the listing to the host server; and
code that directs the processor to notify the user of the listing.

11. A computer-implemented method for listing an item for sale comprising:
requesting entry of image data using a wireless communication device;
initiating an integrated camera mode in the device to create an image of an item;
displaying the image;
determining if the image is acceptable and, if affirmative, saving the image;
requesting and receiving descriptive data for the item;
storing the descriptive data and image data on the device as a listing; and
submitting the listing wirelessly through the device to a provider host.

12. The computer-implemented method as defined in claim 11, wherein requesting and receiving descriptive data for the item comprises:
requesting an image description;
accepting entry of a description of the image on the keypad;
requesting an item name on a display of a wireless device;
accepting entry of the name using a keypad on the device;
requesting a listing title;
accepting entry of the listing title on the keypad;
requesting identifying data for the item; and
accepting entry of the indentifying data on the keypad.

13. The computer-implemented method as defined in claim 12, wherein the storing of the descriptive data includes storing item image name, listing title and identifying data.

14. The computer-implemented method as defined in claim 12, wherein the identifying data includes item condition, manufacturer, model number and item description.

15. The computer-implemented method as defined in claim 11 further comprising:
wirelessly connecting the communications device to the provider host;
transmitting registration information from the device to the provider host;
verifying the information input at the provider host;
if an invalid input is received, returning an appropriate message to the device;
if a valid input is received storing the registration in formation in a database associated with the provider host;
sending an e-mail from the provider host to the device providing access information and downloadable application software modules;
installing the application software modules on the device; and
enabling the device for account login.

16. The computer-implemented method as defined in claim 15 further comprising:
verifying the device registration information and application software modules;
if valid, providing a validation code to be stored in the device;
and wherein the step of submitting a listing further includes the initial steps of
logging in to the account on the provider host using the validation code; and
if an invalid input is received upon account login, responding with an error message.

17. A system for listing an item on an online auction or sale service, the system comprising:
a network;
a wireless communication device for transmitting a listing to the online auction or sale service through the network, wherein the wireless communication device obtains image data of the item from a camera coupled to the wireless communication device, displays the image to a user of the wireless communication device, and if accepted by the user, request and receives descriptive data for the item to generate the listing; and
a provider host for receiving the listing through the network and hosting the online auction or sale service, wherein the provider host receives registration information from the wireless communication device, verifies the information, and if verified, displays the listing on the online auction or sale service provided by the provider host.

18. The system for listing an item on an online auction or sale service as defined in claim 17, wherein the provider host further sends electronic mail to the wireless communication device through the network in order for the wireless communication device to install application software modules.

19. A server coupled to a network for hosting an online auction or sale service, the server comprising:
at least one processor; and
a memory operatively coupled to the processor, the memory storing program instructions that when executed by the processor, causes the processor to:
receive registration information from at least one wireless communication device through the network;
verify the registration information from the at least one wireless communication device;
if valid registration information is received, accept listing information from the at least one wireless communication device, wherein the listing information contains image data and descriptive data of an item to place on the online auction or sale service hosted by the server, the image data taken from a camera integrated in the at least one wireless communication device.

20. The server coupled to a network for hosting an online auction or sale service as defined in claim 19, the memory further storing program instructions that when executed by the processor, cause the processor to further return an invalid registration message to the at least one communication device if invalid registration information is received.

21. The server coupled to a network for hosting an online auction or sale service as defined in claim 19, the memory further storing program instructions that when executed by the processor, cause the processor to further send an electronic mail to the at least one wireless communication device, the electronic mail providing access to software information and download application software modules.

22. The server coupled to a network for hosting an online auction or sale service as defined in claim 19, the memory further storing program instructions that when executed by the processor, cause the processor to further send an electronic mail to the at least one wireless communication device, the electronic mail providing access to software information and download application software modules.
